(19) United States
(12) Patent Application Publication
(10) Pub. No.: US 2014/0340297 A1
(43) Pub. Date: Nov. 20, 2014

(54) LIQUID CRYSTAL DISPLAY DEVICE

(71) Applicant: Panasonic Liquid Crystal Display Co., Ltd., Himeji-shi (JP)

(72) Inventors: Ryutaro OKE, Osaka (JP); Ikuko IMAJO, Osaka (JP); Junichi MARUYAMA, Osaka (JP)

(21) Appl. No.: 14/449,922

(22) Filed: Aug. 1, 2014

Related U.S. Application Data
(63) Continuation of application No. PCT/JP2013/000501, filed on Jan. 30, 2013.

(30) Foreign Application Priority Data
Feb. 16, 2012 (JP) 2012-031220

(51) Int. Cl. G09G 3/36

(52) U.S. Cl. CPC G09G 3/3666; G09G 2310/0243; G09G 2310/0267; G09G 2310/061; G09G 2320/0233
USPC 345/103

(57) ABSTRACT

In a liquid crystal display device that performs horizontal divisional-drive operation, writing of a pixel voltage to pixels in a head row in vertical scanning of each display region becomes insufficient, and a dark line is displayed when the head row is located at the screen center, deteriorating the image quality. For example, a scanning line drive circuit to drive gate lines of a lower display region sequentially outputs a scanning pulse (Pₖ) for selecting a (n+k)th row of an image. A video line drive circuit to drive source lines of the lower display region outputs a pixel voltage corresponding to data (Dₙ₊ₖ) during a period of the scanning pulse (Pₖ). An application start timing of the pixel voltage with respect to application of the scanning pulse (Pₖ) is set earlier in a (n+1)th row, a head row, during an effective scanning period (T_{EFF}) than in the subsequent rows.

### CROSS-REFERENCE TO RELATED APPLICATION

This application is Bypass Continuation of international patent application PCT/JP2013/000501, filed: Jan. 30, 2013 designating the United States of America, the entire disclosure of which is incorporated herein by reference. Priority is claimed based on Japanese patent application JP2012-031220, filed: Feb. 16, 2012. The entire disclosure of Japanese patent application JP2012-031220 is incorporated herein by reference in its entirety.

### TECHNICAL FIELD

This application relates to a liquid crystal display device, and more particularly, to a technology of horizontally dividing a screen into a plurality of display regions and vertically scanning the plurality of display regions in parallel.

### BACKGROUND

Liquid crystal display devices are used in products such as a flat panel TV, a personal computer, a tablet terminal, and a smartphone. Particularly in applications of large-sized panels as represented by the flat panel TV, in order to achieve high-definition image display and three-dimensional display and in order to improve a moving image quality, there are demands for increase in the number of pixels, such as 4K resolution (4K2K), and drive at a higher frame rate, such as double-speed or quad-speed drive. Those demands may shorten a data writing time that is assigned to each horizontal scanning line in vertical scanning of a screen, and may cause a problem that data written to a pixel is insufficient when a general drive method is employed. As one solution to this problem, there is known a divisional-drive method involving dividing the screen into a plurality of display regions and writing data into the respective display regions in parallel.

However, in a divisional drive involving horizontally dividing the screen into two regions, upper and lower display regions, the following problem arises: an unintended brightness change appears at a boundary between the display regions in a display image of the liquid crystal display device, and a joint of the display regions is visible on the image. A solution to the problem has been discussed in Japanese Patent Application Laid-open Nos. 2000-321552, 2008-70406, and Hei 11-102172.

Regarding the above-mentioned problem that the joint of the display regions is visible, there are causes that are not discussed in the above-mentioned patent literatures. FIGS. 7 to 10 are used to describe a cause of displaying the joint, which is addressed in this application.

FIG. 7 is a schematic view of a screen in a divisional drive involving equally dividing the screen into two regions, upper and lower regions. A vertical scanning of a display region A_{U} in the upper half of the screen and a vertical scanning of a display region A_{D} in the lower half the screen are performed in parallel. The screen includes 2n (n is a natural number) horizontal scanning lines, specifically, first to 2n-th horizontal scanning lines in the order from the top.

FIG. 8 is a schematic timing diagram of signals VS_{U} and VS_{D} that are voltage signals to be supplied to source lines (video lines) of the regions A_{U} and A_{D} respectively, and signals VG₁ to VG₂ₙ that are voltage signals to be supplied to gate lines (scanning lines) provided so as to respectively correspond to the first to 2n-th horizontal scanning lines. The region A_{U} (first to n-th rows) and the region A_{D} ((n+1)th to 2n-th rows) are vertically scanned in descending order as indicated by the arrows in FIG. 7, for example. Correspondingly, during an effective scanning period T_{EFF} of the vertical scanning, a scanning pulse Pₖ (selection signal) is sequentially generated for a signal VGₖ and a signal VGₙ₊ₖ (k=1 to n).

The signals VS_{U} and VS_{D} are each set to a reference voltage V_{BLK}, which corresponds to a pixel value representing black, during a blanking period T_{BLK} of the vertical scanning. On the other hand, during the effective scanning period T_{EFF}, the signal VS_{U} and VS_{D} are respectively set to signal voltages Vₖ and Vₙ₊ₖ, which represent pixel values Dₖ and Dₙ₊ₖ of pixels in k-th and (n+k)th rows, in synchronization with the scanning pulse Pₖ. In this case, for simplifying the description, it is assumed that the pixel values D₁ to D₂ₙ of 2n pixels arrayed in a direction along the source line (column direction) are the same. In correspondence to this, in FIGS. 8 to 10, the signals VS_{U} and VS_{D} during the effective scanning period T_{EFF} are represented by constant voltages. Note that, due to frame inversion drive, the signals VS_{U} and VS_{D} have their polarities with respect to the reference voltage V_{BLK} inverted in adjacent effective scanning periods T_{EFF}.

FIGS. 9 and 10 are schematic signal waveform diagrams illustrating the signals VS_{D} and VGₙ₊ₖ of the display region A_{D} and a potential VP of a pixel electrode in a non-head part and a head part of the effective scanning period T_{EFF}, respectively. In a thin film transistor (TFT) provided in each pixel, when the scanning pulse Pₖ is applied to a gate electrode, a channel between the source line and the pixel electrode enters an on state, and the pixel electrode is charged to a potential corresponding to the signal VS_{D}. A relationship between a timing for setting the signal VS_{D} to a signal voltage Vₙ₊ₖ corresponding to the pixel value Dₙ₊ₖ and a timing for applying the scanning pulse Pₖ is set so as to improve the efficiency of writing the signal voltage Vₙ₊ₖ to the pixel electrode, while considering such an influence that the waveform of the scanning pulse Pₖ is rounded due to a capacitance and wiring resistance accompanying the gate line. Therefore, while a period in which the signal voltage Vₙ₊ₖ is not applied is generated at the rising of the scanning pulse Pₖ, the tail end of the period of applying the signal voltage Vₙ₊ₖ may overlap a period of rising of the scanning pulse Pₖ₊₁ for the next row. In writing to pixels of a (n+α)th row (2≦α≦n) that is a non-head row, as illustrated in FIG. 9, a signal voltage V_{n+α-1} for the previous row is applied during the period of the rising of the scanning pulse P_{α} for the (n+α)th row, and thus the potential VP of the pixel electrode is increased in advance before the start of application of the signal voltage V_{n+α} for the (n+α)th row. Then, during the period of applying the signal voltage V_{n+α} for the (n+α)th row, the potential VP changes toward the signal voltage V_{n+α} starting from the potential increased in advance. In contrast, in writing to pixels in the (n+1)th row that is the head row, as illustrated in FIG. 10, the reference voltage V_{BLK} that is lower than the signal voltage Vₙ for the previous row (in other words, the lowermost row of the upper display region A_{U}) is applied during the period of the rising of the scanning pulse P₁ for the (n+1)th row, and hence the rising of the potential VP of the pixel electrode before the start of the application of the signal voltage Vₙ₊₁ for the (n+1)th row is gentler than that in the case of the non-head row illustrated in FIG. 9. Therefore, the increase of the potential VP during the period of applying the signal voltage Vₙ₊₁ for the (n+1)th row is started from a potential lower than that in the case of the non-head row. Thus, the signal voltage for the (n+1)th row is lower than that in the case of the non-head row. In other words, even when the pixel values are the same, the writing of the signal voltage to pixels becomes insufficient in the (n+1)th row as compared to the n-th row and the (n+2)th row that are adjacent to the (n+1)th row, which causes a problem that the (n+1)th row is displayed dark in the screen.

The insufficient writing to pixels in the head row in the vertical scanning occurs even in the head row in a general drive method that does not horizontally divide the screen. However, brightness reduction due to the insufficient writing to pixels occurs in the row at the end of the screen, and hence the brightness reduction is less obvious. As compared thereto, the brightness change in a region other than that at the end of the screen is visually recognizable as in the above-mentioned display region A_{D}.

This application has been made to solve the above-mentioned problem, and has an object to provide a liquid crystal display device configured to perform a horizontal divisional drive, in which, in a case where one of a plurality of display regions obtained by dividing a screen starts vertical scanning from a row that is adjacent to another display region, an unintended brightness change appears less at a boundary between the display regions.

### SUMMARY

According to one embodiment of this application, there is provided a liquid crystal display device, including: video lines, which are provided in each of a plurality of display regions obtained by horizontally dividing a screen including a plurality of pixels arranged in matrix, so as to correspond to respective columns of the plurality of pixels; a scanning line drive circuit configured to sequentially supply a selection signal to a plurality of scanning lines, which are provided in each of the plurality of display regions so as to correspond to respective rows of the plurality of pixels, to thereby perform vertical scanning of the plurality of display regions in parallel; and a video line drive circuit configured to: apply, during a blanking period of the vertical scanning, a predetermined reference voltage to the video lines; and apply, during an effective scanning period of the vertical scanning, a signal voltage corresponding to a pixel value via one of the video lines to corresponding one of the plurality of pixels in a selected row that is supplied with the selection signal via one of the plurality of scanning lines, the liquid crystal display device being configured to divisionally drive the screen, in which the scanning line drive circuit starts the vertical scanning for a specific scanning display region predetermined out of the plurality of display regions from a pixel row that is adjacent to another of the plurality of display regions, and in which the video line drive circuit sets, in at least the specific scanning display region out of the plurality of display regions, an application start timing of the signal voltage related to a supply start timing of a selection signal to be earlier in a selected row at a head of the effective scanning period than in a selected row subsequent thereto.

According to another embodiment of this application, there is provided a liquid crystal display device, including: video lines, which are provided in each of a plurality of display regions obtained by horizontally dividing a screen including a plurality of pixels arranged in matrix, so as to correspond to respective columns of the plurality of pixels; a scanning line drive circuit configured to sequentially supply a selection signal to a plurality of scanning lines, which are provided in each of the plurality of display regions so as to correspond to respective rows of the plurality of pixels, to thereby perform vertical scanning of the plurality of display regions in parallel; and a video line drive circuit configured to: apply, during a blanking period of the vertical scanning, a predetermined reference voltage to the video lines; and apply, during an effective scanning period of the vertical scanning, a signal voltage corresponding to a pixel value via one of the video lines to corresponding one of the plurality of pixels in a selected row that is supplied with the selection signal via one of the plurality of scanning lines, the liquid crystal display device being configured to divisionally drive the screen, in which the scanning line drive circuit starts the vertical scanning for a specific scanning display region predetermined out of the plurality of display regions from a pixel row that is adjacent to another of the plurality of display regions, and in which the video line drive circuit applies, in at least the specific scanning display region out of the plurality of display regions, instead of the predetermined reference voltage, a preset voltage corresponding to the pixel value of an intermediate grayscale during a transition period of a predetermined length at an end of the blanking period prior to a start of application of the signal voltage during the effective scanning period.

According to still another embodiment of this application, there is provided a liquid crystal display device, including: video lines, which are provided in each of a plurality of display regions obtained by horizontally dividing a screen including a plurality of pixels arranged in matrix, so as to correspond to respective columns of the plurality of pixels; scanning lines provided so as to correspond to respective rows of the plurality of pixels; a switching element that is provided in each of the plurality of pixels and is configured to control conduction between a pixel electrode and corresponding one of the video lines based on a voltage applied to corresponding one of the scanning lines; a scanning line drive circuit configured to sequentially apply a selection voltage for passing electricity through the switching element to a plurality of the scanning lines provided in each of the plurality of display regions, to thereby perform vertical scanning of the plurality of display regions in parallel; and a video line drive circuit configured to: apply, during a blanking period of the vertical scanning, a predetermined reference voltage to the video lines; and apply, during an effective scanning period of the vertical scanning, a signal voltage corresponding to a pixel value via one of the video lines to corresponding one of the plurality of pixels in a selected row that is applied with the selection voltage via one of the scanning lines, the liquid crystal display device being configured to divisionally drive the screen, in which the scanning line drive circuit is configured to: start the vertical scanning for a specific scanning display region predetermined out of the plurality of display regions from a pixel row that is adjacent to another of the plurality of display regions; and control, in at least the specific scanning display region out of the plurality of display regions, the selection voltage so that the switching element in a selected row at a head of the effective scanning period enters a conductive state with a resistance lower than a resistance of a selected row subsequent thereto.

According to still another embodiment of this application, there is provided a liquid crystal display device, including: video lines, which are provided in each of a plurality of display regions obtained by horizontally dividing a screen including a plurality of pixels arranged in matrix, so as to correspond to respective columns of the plurality of pixels; a scanning line drive circuit configured to sequentially supply a selection signal to a plurality of scanning lines, which are provided in each of the plurality of display regions so as to correspond to respective rows of the plurality of pixels, to thereby perform vertical scanning of the plurality of display regions in parallel; and a video line drive circuit configured to: apply, during a blanking period of the vertical scanning, a predetermined reference voltage to the video lines; and apply, during an effective scanning period of the vertical scanning, a signal voltage corresponding to a pixel value via one of the video lines to corresponding one of the plurality of pixels in a selected row that is supplied with the selection signal via one of the plurality of scanning lines, the liquid crystal display device being configured to divisionally drive the screen, in which the scanning line drive circuit starts the vertical scanning for a specific scanning display region predetermined out of the plurality of display regions from a pixel row that is adjacent to another of the plurality of display regions, and in which the video line drive circuit sets, in at least the specific scanning display region out of the plurality of display regions, during at least a part of a period of applying the signal voltage corresponding to a pixel value in a selected row at a head of the effective scanning period, the signal voltage to be larger than a signal voltage that is applied to another selected row for the pixel value.

According to this application, in the liquid crystal display device configured to perform the horizontal divisional drive, in the case where one of the plurality of display regions obtained by dividing the screen starts the vertical scanning from the row that is adjacent to another display region, the unintended brightness change can be made less likely to appear at the boundary between the display regions, and an image quality can be enhanced.

### BRIEF DESCRIPTION OF THE DRAWINGS

FIG. 1 is a schematic view illustrating a configuration of a liquid crystal display device according to an embodiment of this application.

FIG. 2 is a signal waveform diagram illustrating an operation of writing a pixel voltage to a pixel in a head row of a specific display region in a liquid crystal display device according to a first embodiment of this application.

FIG. 3 is a schematic block diagram illustrating an example of a circuit configuration for advancing an application timing of a signal voltage by a period of 1 H in a head row.

FIG. 4 is a signal waveform diagram illustrating an operation of writing a pixel voltage to a pixel in a head row of a specific display region in a liquid crystal display device according to a second embodiment of this application.

FIG. 5 is a signal waveform diagram illustrating an operation of writing a pixel voltage to a pixel in a head row of a specific display region in a liquid crystal display device according to a third embodiment of this application.

FIG. 6 is a signal waveform diagram illustrating an operation of writing a pixel voltage to a pixel in a head row of a specific display region in a liquid crystal display device according to a fourth embodiment of this application.

FIG. 7 is a schematic view of a screen in a divisional drive involving equally dividing the screen into two regions, upper and lower regions.

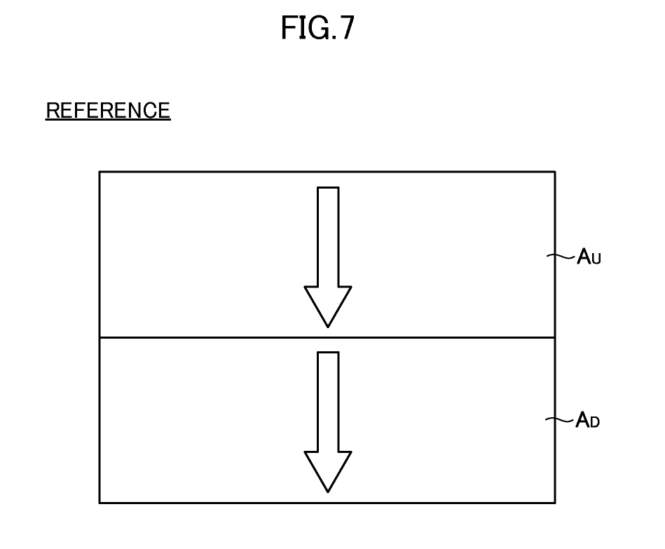

FIG. 8 is a schematic timing diagram of voltage signals to be supplied to source lines and gate lines of upper and lower display regions respectively.

FIG. 9 is a schematic signal waveform diagram illustrating voltage signals to be supplied to the source lines and the gate lines and a potential of a pixel electrode in a non-head part of an effective scanning period T_{EFF}.

FIG. 10 is a schematic signal waveform diagram illustrating the voltage signals to be supplied to the source lines and the gate lines and the potential of the pixel electrode in a head part of the effective scanning period T_{EFF}.

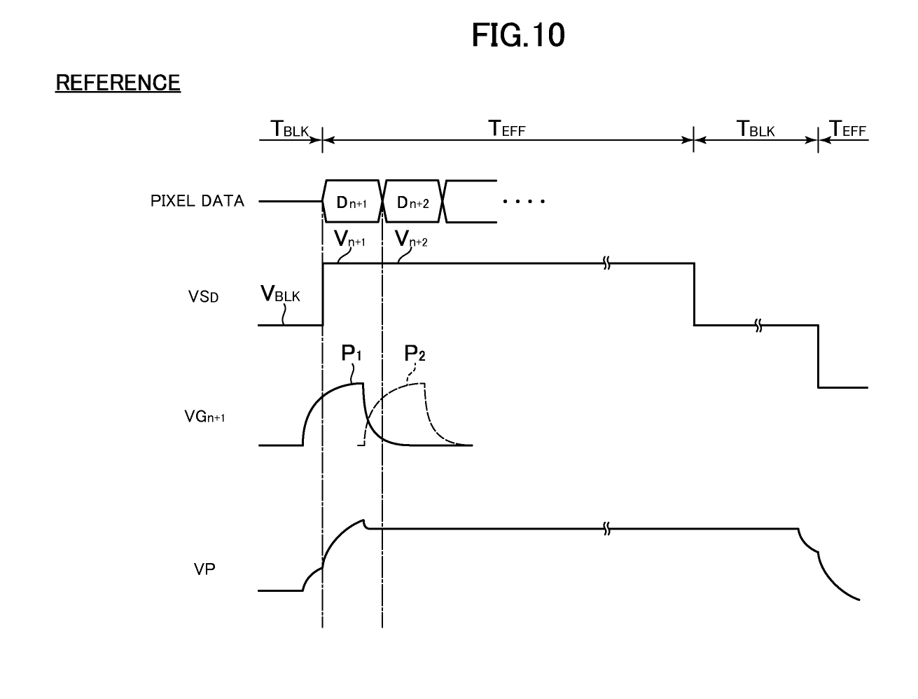

### DETAILED DESCRIPTION

Now, modes for carrying out this application (hereinafter referred to as “embodiments”) are described with reference to the drawings.

### First Embodiment

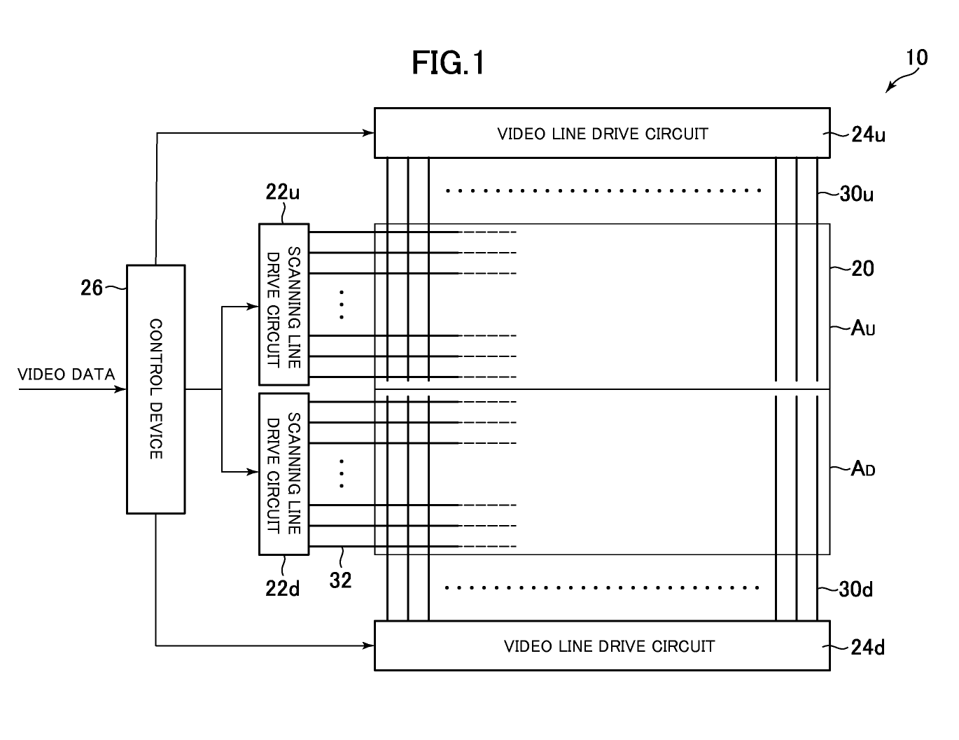

FIG. 1 is a schematic view illustrating a configuration of a liquid crystal display device 10 according to a first embodiment of this application. The liquid crystal display device 10 includes a liquid crystal panel 20, scanning line drive circuits 22u and 22d, video line drive circuits 24u and 24d, a control device 26, a backlight unit (not shown), and a backlight drive circuit (not shown).

The liquid crystal display device 10 employs, for example, an in-plane switching (IPS) method and an active matrix drive method. The liquid crystal panel 20 includes a color filter substrate and a TFT substrate that are arranged so as to oppose each other with a gap provided therebetween. Liquid crystal is filled into the gap provided therebetween. Polarizing films are bonded to outer side surfaces of respective glass substrates that form the color filter substrate and the TFT substrate. The TFT substrate is located on the back surface side of the liquid crystal panel 20, and the backlight unit is arranged behind it. On the other hand, the color filter substrate is located on the display surface side of the liquid crystal panel 20.

On a surface of the TFT substrate on the liquid crystal side, TFTs, pixel electrodes, a common electrode, wiring therefor, and the like are formed. Specifically, the pixel electrodes and the TFTs are arranged in matrix so as to correspond to a pixel arrangement. In each of the pixels, the common electrode made of a transparent electrode material as well as the pixel electrode is arranged. As the wiring, a plurality of source lines 30, a plurality of gate lines 32, and common electrode wiring are formed. The plurality of source lines 30 and the plurality of gate lines 32 are arranged so as to be substantially orthogonal to each other. Each of the gate lines 32 is provided for each row (line in the horizontal direction) of the TFTs, and is connected in common to gate electrodes of the plurality of TFTs in the corresponding row. Each of the source lines 30 is provided for each column (line in the vertical direction) of the TFTs, and is connected in common to sources of the plurality of TFTs in the corresponding column. Further, to a drain of each TFT, the pixel electrode corresponding to the TFT is connected.

Conductive states of each TFTs in a row are controlled as a whole based on a scanning pulse applied to the gate line 32. The pixel electrode is connected to the source line 30 via the TFT in the on state, and a signal voltage (pixel voltage) corresponding to a pixel value is applied to the pixel electrode from the source line 30. A predetermined common potential is applied to the common electrode via the common electrode wiring. The liquid crystal has its orientation controlled for each pixel by an electric field generated based on the potential difference between the pixel electrode and the common electrode. Thus, the transmittance of light entering from the backlight unit is changed, to thereby form an image on the display surface.

The liquid crystal display device 10 employs a divisional-drive method involving horizontally dividing the screen into two regions, upper and lower display regions. In this case, the total number of pixel rows forming the screen is 2n (n is a natural number), and the screen is equally divided into two regions, upper and lower regions, so that a display region A_{U} corresponding to the upper half of the screen and a display region A_{D} corresponding to the lower half of the screen are vertically scanned in parallel.

In order to perform the divisional drive, each of the source lines 30 is divided at a boundary between the regions A_{U} and A_{D} into a source line 30u arranged in the region A_{U} and a source line 30d arranged in the region A_{D}. The video line drive circuit 24u is connected to the source lines 30u, and the video line drive circuit 24d is connected to the source lines 30d. The first to n-th gate lines 32 from the top of the screen are arranged in the display region A_{U}, and those gate lines 32 are connected to the scanning line drive circuit 22u. Further, the (n+1)th to 2n-th gate lines 32 arranged in the display region A_{D} are connected to the scanning line drive circuit 22d.

A video signal received by a tuner or an antenna (not shown) or a video signal generated by another device such as a video reproduction device is input to the control device 26. The control device 26 includes a central processing unit (CPU) and a memory such as a read only memory (ROM) and a random access memory (RAM).

The control device 26 performs various image signal processing such as color adjustment with respect to the input video signal, and generates pixel data representing a grayscale value of each pixel. For example, the control device 26 holds, in the RAM, pixel data for one frame obtained from line-sequentially input video signals, and reads the pixel data in a desired order for each row, to thereby output the pixel data to the video line drive circuits 24u and 24d. Further, the control device 26 generates, based on the input video signals, timing signals for the scanning line drive circuits 22u and 22d, the video line drive circuits 24u and 24d, and the backlight drive circuit to synchronize with each other, and outputs the timing signals toward the respective drive circuits.

Each of the scanning line drive circuits 22u and 22d sequentially selects the gate line 32 based on the timing signal input from the control device 26, and starts an operation of outputting the scanning pulse to the selected gate line 32. In this embodiment, the scanning line drive circuit 22u sequentially selects the gate lines 32 from the first row to the n-th row, and in parallel thereto, the scanning line drive circuit 22d sequentially selects the gate lines 32 from the (n+1)th row to the 2n-th row.

The pixel data of the selected row is input to the video line drive circuits 24u and 24d from the control device 26 in synchronization with the selection of the gate line 32 by each of the scanning line drive circuits 22u and 22d, respectively, and the video line drive circuits 24u and 24d generates a voltage corresponding to the pixel data of the selected row. Then, this voltage is output as a pixel voltage to the source lines 30u and 30d. With this, in each of the display regions A_{U} and A_{D}, the pixel voltage is applied to the pixel electrode corresponding to the selected gate line 32. By the way, this operation corresponds to horizontal scanning of raster graphics, in which a row is selected in each of display regions A_{U} and A_{D} for each horizontal scanning cycle during the effective scanning period, and a pixel voltage is written to pixels in the corresponding row. For example, a vertical scanning cycle (1V), an effective scanning period T_{EFF}, and a blanking period T_{BLK} in the liquid crystal display device 10 are set to be equivalent to an effective display period and a blanking period of vertical scanning of the video signal. Further, a horizontal scanning cycle (1 H) can be set based on a horizontal synchronizing signal of the video signal.

Each of the video line drive circuits 24u and 24d outputs a pixel voltage corresponding to the selected row to the source line 30 basically for each period of 1 H during the effective scanning period T_{EFF}. In the writing operation for each row, the potential of the pixel electrode at the time when the TFT is turned off is basically held until the writing to a pixel in the selected row is started in the next frame. During this period, each pixel in the selected row is controlled to have a transmittance corresponding to the potential. Note that, in this embodiment, the polarity of the pixel voltage is inverted for each frame due to the frame inversion drive. During the blanking period T_{BLK}, the video line drive circuits 24u and 24d basically output a predetermined reference voltage V_{BLK} to each of the source lines 30. In this case, deterioration of the image quality occurs when an unnecessary DC potential is applied to the pixel electrode due to a leak current of the TFT or the like. In order to prevent this, it is preferred to basically set the reference voltage V_{BLK} to a potential corresponding to a pixel value representing black.

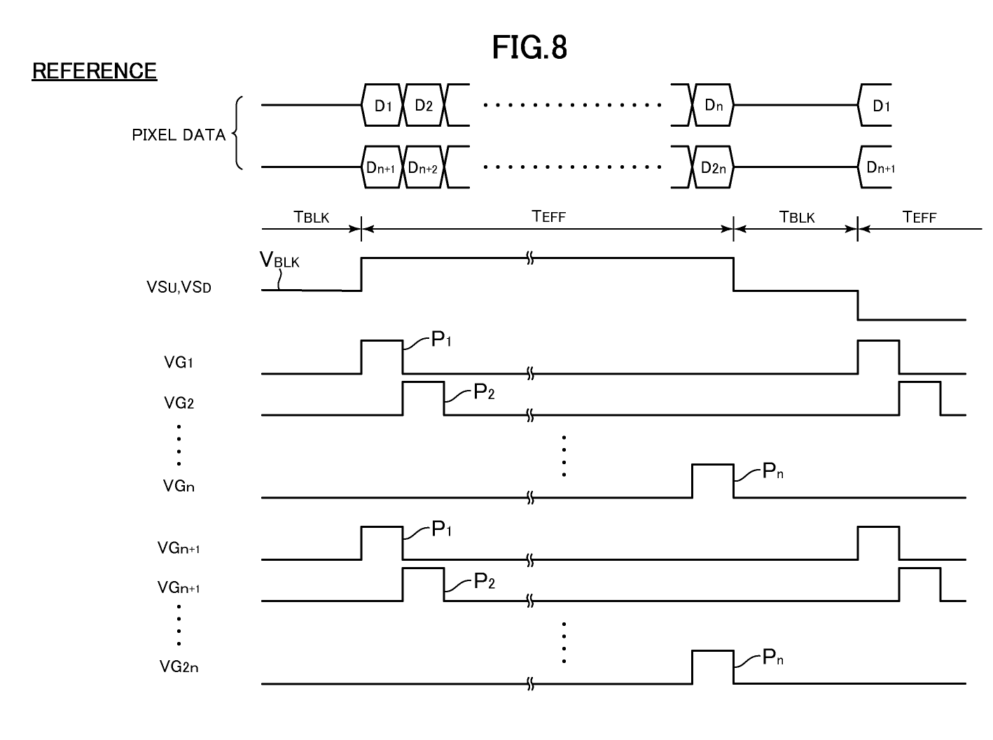

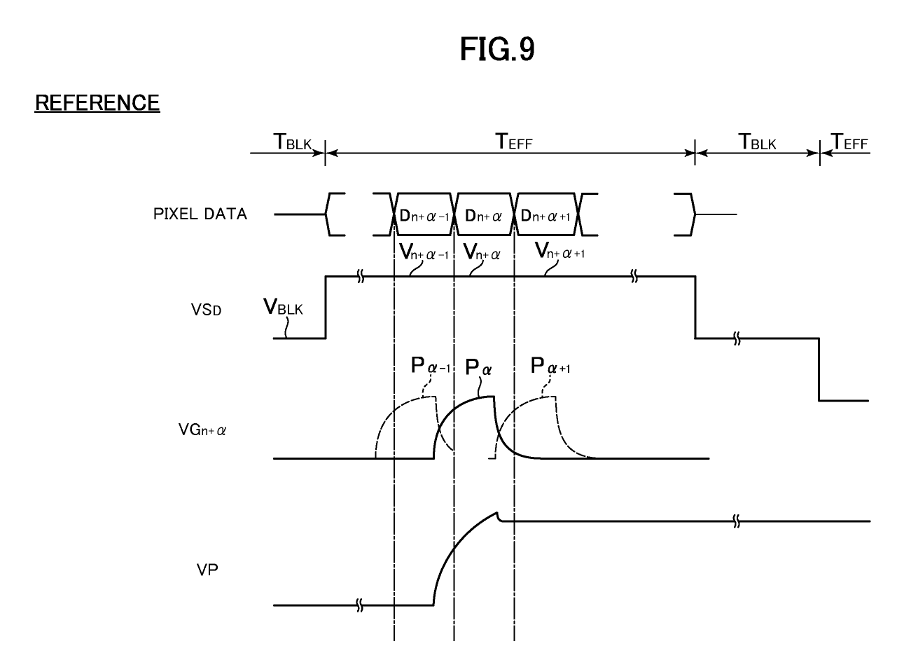

FIG. 8 can be referred to as a timing diagram of signals VS_{U} and VS_{D} to be applied to the source lines 30u and 30d and signals VG₁ to VG₂ₙ to be applied to the first to 2n-th gate lines 32 in this embodiment. Further, writing of the pixel voltage to a pixel in a non-head row during each effective scanning period T_{EFF} is similarly performed as the operation described above with reference to FIG. 9.

Now, description is given of an operation of writing the pixel voltage to a pixel in a head row during each effective scanning period T_{EFF}, which is a feature of this application. As described above, this application has an object of eliminating the insufficient writing to pixels in the head row in a case where vertical scanning of a display region set through horizontal division is started from a pixel row that is adjacent to another display region. Now, a display region whose vertical scanning is started from a pixel row that is adjacent to another display region is referred to as “specific display region”. In this embodiment, the lower display region A_{D} is the specific display region.

In this embodiment, the video line drive circuit sets, in at least the specific scanning display region out of the plurality of display regions, an application start timing of the pixel voltage based on a timing of a scanning pulse for each selected row to be earlier in a selected row at the head of the effective scanning period T_{EFF} (head row) than in a selected row subsequent thereto (non-head row).

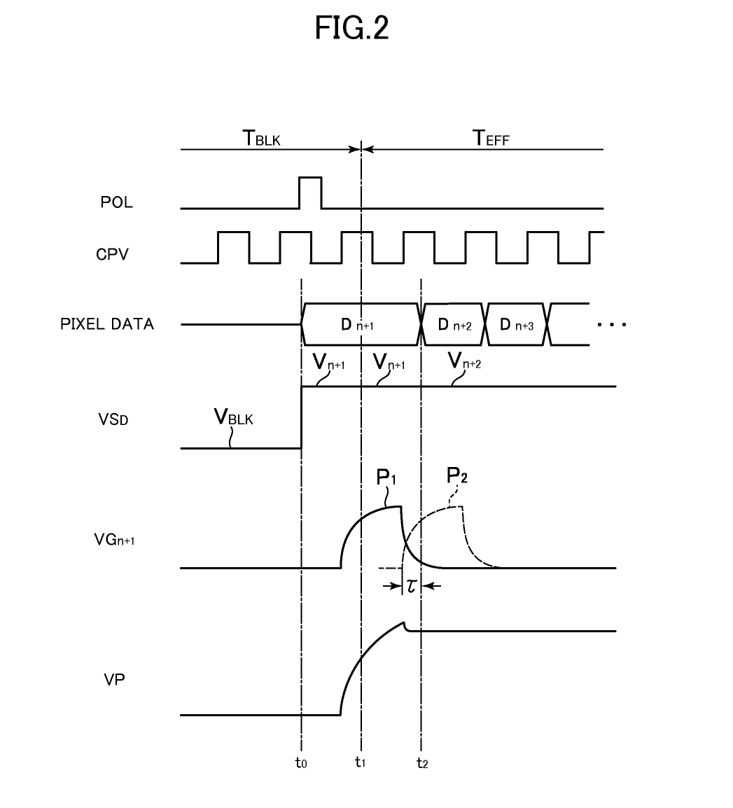

FIG. 2 is a signal waveform diagram illustrating the operation of writing the pixel voltage to a pixel in the head row of the region A_{D} that is the specific display region, and schematically illustrates signal waveforms of the signals VS_{D} and VGₙ₊₁ and the potential VP of the pixel electrode. The control device 26 keeps time based on a dot clock signal, for example, to thereby generate a signal POL that generates a pulse in a cycle of 1V and a clock signal CPV of a cycle of 1 H. Further, the control device 26 sets, based on a timing of the pulse of the signal POL, a start/end timing of the effective scanning period T_{EFF} or start/end timing of the blanking period T_{BLK}, and an output timing of a trigger signal to the scanning line drive circuit 22d (and the scanning line drive circuit 22u).

The scanning line drive circuit 22d starts an operation of a shift register based on the trigger signal from the control device 26. The output of each stage of the shift register is sequentially connected to the gate lines 32 in the (n+1) th to 2n-th rows, and the scanning pulse is sequentially output to the gate lines 32 from the head stage in synchronization with the clock signal CPV. For example, the shift register causes the scanning pulse to rise for a certain row in synchronization with the rising of the clock signal CPV, and causes the scanning pulse to fall in synchronization with the rising of the clock signal CPV 1 H later.

As described above, a phase difference between a period in which the video line drive circuit 24d outputs the signal voltage Vₙ₊ₖ corresponding to the pixel value Dₙ₊ₖ to the source line 30 and a period in which the scanning line drive circuit 22d applies the scanning pulse Pₖ to the gate line 32 is set so as to achieve a preferred efficiency of writing the signal voltage Vₙ₊ₖ to the pixel electrode. When the period corresponding to the phase difference is represented by τ, in this embodiment, application of the signal voltage V_{n+α} to the (n+α)th row (2≦α≦n) that is a non-head row is started from a time point t_{α} which is after the rising timing of the scanning pulse P_{α} by period τ.

In contrast, application of the signal voltage Vₙ₊₁ to the head row is started from a time point t₀ that is prior to a time point t₁ that is after the rising of the scanning pulse P₁ by τ. The time point t₀ is preferred to be set before the rising timing of the scanning pulse P₁. With this, simultaneously with the turning-on of the TFT in the head row, the signal voltage Vₙ₊₁ is applied to the pixel electrode, and the potential VP rapidly rises. Therefore, the insufficiency in writing of the pixel voltage to a pixel as compared to other rows is eliminated or reduced. In this manner, it is possible to prevent deterioration of the image quality, which is caused because a row other than that at the end of the screen is unnecessarily displayed dark.

Starting the application of the signal voltage Vₙ₊₁ earlier substantially corresponds to applying a voltage different from the reference voltage V_{BLK} to the source line 30 at an end part of the vertical blanking period T_{BLK}. In this case, considering that, as described above, it is preferred to basically set the potential of the source line 30 in the vertical blanking period T_{BLK} to the reference voltage V_{BLK} corresponding to black, the time point t₀ should not be set earlier excessively, and the time point t₀ can be basically set to match with the rising timing of the scanning pulse P₁. In an actual case, considering a time constant of the signal VS_{D} or the like during transition from the reference potential V_{BLK} to the signal voltage Vₙ₊₁, the time point t₀ is set prior to the rising timing of the scanning pulse P₁, and can be set to a time point prior to the time point t₁ by a period of 1 H, for example.

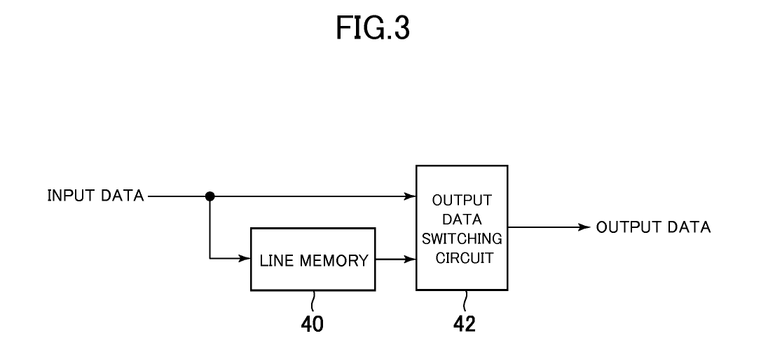

FIG. 3 is a schematic block diagram illustrating an example of a circuit configuration for advancing an application timing of the signal voltage Vₙ₊ₖ by a period of 1 H in the head row. The circuit illustrated in FIG. 3 is provided in the control device 26, for example . The pixel data for the display region A_{D} is input in parallel to a line memory 40 and an output data switching circuit 42 in the scanning order. The line memory 40 delays the input data for a period of 1 H, and then outputs the data to the output data switching circuit 42. The output data switching circuit 42 outputs, for the head row, directly input pixel data to the video line drive circuit 24d at the time point t₀, and outputs the pixel data input from the line memory 40 to the video line drive circuit 24d 1 H later at the time point t₁. From then on, for each period of 1 H, the output data switching circuit 42 outputs the pixel data of the non-head row, which is input from the line memory 40, to the video line drive circuit 24d.

Note that, also in the upper display region A_{U} in which the head row of the vertical scanning is located at the screen end, similarly to the lower display region A_{D} described above, a configuration and an operation for compensating for the insufficient writing of the pixel voltage to a pixel in the head row may be adopted, to thereby prevent the row at the screen end from being displayed dark.

### Second Embodiment

A schematic configuration of a liquid crystal display device according to a second embodiment of this application is basically the same as that in the liquid crystal display device 10 of the above-mentioned embodiment illustrated in FIG. 1. In the following description, components similar to those of the first embodiment are denoted by the same reference symbols to simplify the description. The points at which this embodiment differs from the first embodiment are the configuration and the operation for compensating for the insufficient writing of the pixel voltage to a pixel in the head row in the vertical scanning of the horizontally divided display regions. Also in this case, the lower display region A_{D} is set as the specific display region, and vertical scanning for the display region A_{D} is used as an example. Now, description is given of the operation of writing the pixel voltage to a pixel in the head row during each effective scanning period T_{EFF}.

In this embodiment, the video line drive circuit applies, in at least the specific scanning display region out of the plurality of display regions, instead of the reference voltage V_{BLK}, a preset voltage corresponding to the pixel value of an intermediate grayscale during a transition period having a predetermined length at the end of the blanking period T_{BLK} prior to the start of application of the signal voltage during the effective scanning period T_{EFF}.

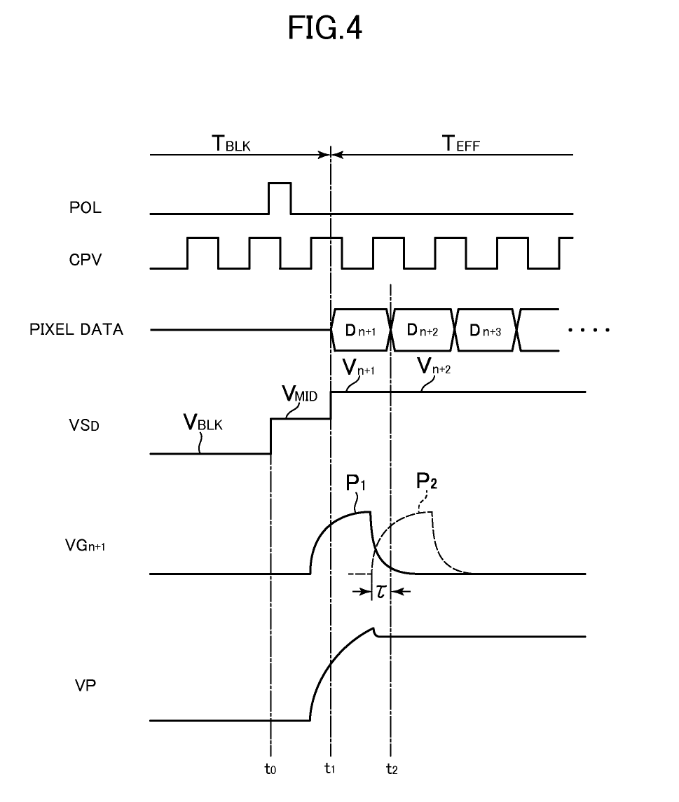

FIG. 4 is a signal waveform diagram illustrating the operation of writing the pixel voltage to a pixel in the head row of the region A_{D} that is the specific display region, and schematically illustrates signal waveforms of the signals VS_{D} and VGₙ₊₁ and the potential VP of the pixel electrode.

In this embodiment, application of the signal voltage Vₙ₊ₖ for each row including the head row, that is, the (n+k)th row (1≦k≦n) is started from a time point tₖ which is after the rising timing of the scanning pulse Pₖ by the period τ.

The transition period is provided prior to the time point t₁, which is the time to start application of the signal voltage Vₙ₊₁ for the head row. The time point t₀ at which the transition period starts is preferred to be set before the rising timing of the scanning pulse P₁, and is set to a time point prior to the time point t₁ by a period of 1 H, for example. At the time point t₀ during the blanking period T_{BLK}, the control device 26 outputs predetermined pixel data of an intermediate grayscale to the video line drive circuit 24d, and the video line drive circuit 24d applies a voltage V_{MID} corresponding to the pixel data to the source line 30 during a period from the time point t₀ to the time point t₁. The pixel data of the intermediate grayscale can be set to be a half of the grayscale levels of the pixel data, for example. Further, an average value from a standard image can be obtained in advance by an experiment or the like, and this value can be set as pixel data of the intermediate grayscale.

In this configuration, the voltage V_{MID}, which is expected to be closer to the signal voltage Vₙ₊₁ than the reference potential V_{BLK} is, is applied to the pixel electrode at the rising of the scanning pulse P₁. With this, the rising of the potential VP in the head row is assisted, and hence the insufficiency in writing of the signal voltage to the pixel electrode as compared to other rows is eliminated or reduced. In this manner, it is possible to prevent a deterioration of the image quality, which is caused because a row other than that at the end of the screen is unnecessarily displayed dark. Further, the pixel data of the intermediate grayscale during the transition period is fixed in each frame, and thus the circuit configuration can be simplified.

### Third Embodiment

A schematic configuration of a liquid crystal display device according to a third embodiment of this application is basically the same as that in the liquid crystal display device 10 of the above-mentioned embodiment illustrated in FIG. 1. In the following description, components similar to those of the first embodiment are denoted by the same reference symbols to simplify the description. The points at which this embodiment differs from the first embodiment are the configuration and the operation for compensating for the insufficient writing of the pixel voltage to a pixel in the head row in the vertical scanning of the horizontally divided display regions. Also in this case, the lower display region A_{D} is set as the specific display region, and vertical scanning for the display region A_{D} is used as an example. Now, description is given of the operation of writing the pixel voltage to a pixel in the head row during each effective scanning period T_{EFF}.

In this embodiment, the scanning line drive circuit controls, in at least the specific scanning display region out of the plurality of display regions, the voltage of the scanning pulse for selecting each row (selection voltage) so that a TFT (switching element) in the selected row at the head of the effective scanning period T_{EFF} enters a conductive state with a resistance lower than that of the selected row subsequent thereto.

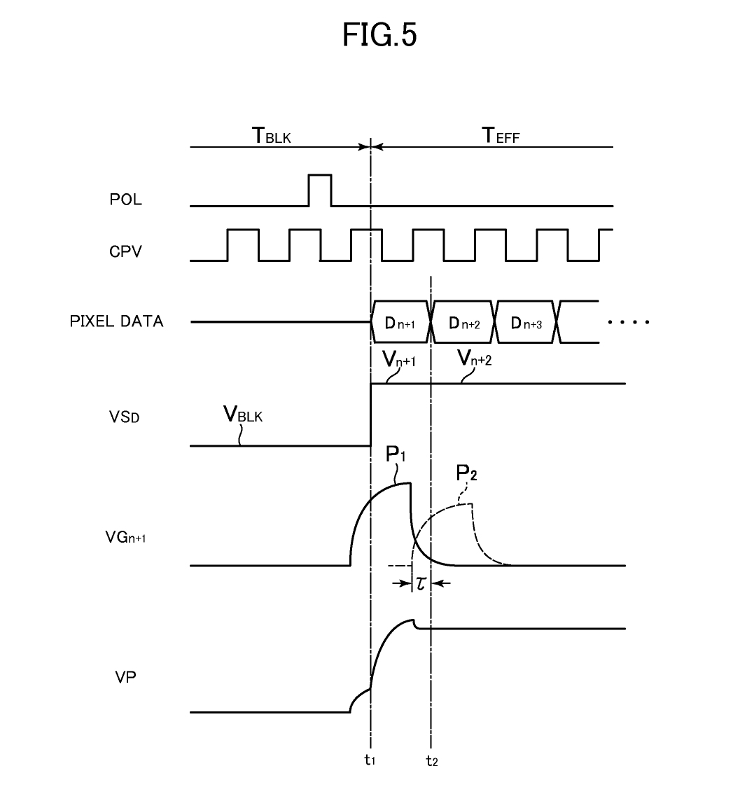

FIG. 5 is a signal waveform diagram illustrating the operation of writing the pixel voltage to a pixel in the head row of the region A_{D} that is the specific display region, and schematically illustrates signal waveforms of the signals VS_{D} and VGₙ₊₁ and the potential VP of the pixel electrode.

In this embodiment, a TFT has an n-channel, and is turned on when a gate voltage is higher than an on-voltage. The scanning line drive circuit 22d sets the voltage of the scanning pulse P₁ for the (n+1)th row that is the head row to be higher than the voltage of the scanning pulse P_{α} for the (n+α)th row (2≦α≦n) that is a non-head row. With this, the TFT in the head row is set to have a conductance higher than that of the TFT in the non-head rows, and thus a state with a lower resistance is achieved.

In this configuration, the rising of the potential VP of the pixel electrode after the start of application of the signal voltage Vₙ₊₁ in the head row is faster than in other rows, and hence the insufficiency in writing of the signal voltage to the pixel electrode as compared to other rows is eliminated or reduced. In this manner, it is possible to prevent a deterioration of the image quality, which is caused because a row other than that at the end of the screen is unnecessarily displayed dark.

For example, the scanning line drive circuit 22d is configured that a stage of the shift register corresponding to the (n+1)th row outputs a pulse with a voltage higher than those in other stages thereof.

### Fourth Embodiment

A schematic configuration of a liquid crystal display device according to a fourth embodiment of this application is basically the same as that in the liquid crystal display device 10 of the above-mentioned embodiment illustrated in FIG. 1. In the following description, components similar to those of the first embodiment are denoted by the same reference symbols to simplify the description. The points at which this embodiment differs from the first embodiment are the configuration and the operation for compensating for the insufficient writing of the pixel voltage to a pixel in the head row in the vertical scanning of the horizontally divided display regions. Also in this case, the lower display region A_{D} is set as the specific display region, and vertical scanning for the display region A_{D} is used as an example. Now, description is given of the operation of writing the pixel voltage to a pixel in the head row during each effective scanning period T_{EFF}.

In this embodiment, the video line drive circuit sets, for at least the specific scanning display region out of the plurality of display regions, during at least a part of a period for applying the signal voltage corresponding to the pixel value in the selected row at the head of the effective scanning period T_{EFF}, the signal voltage to be larger than a signal voltage that is applied to other selected rows for the same pixel value.

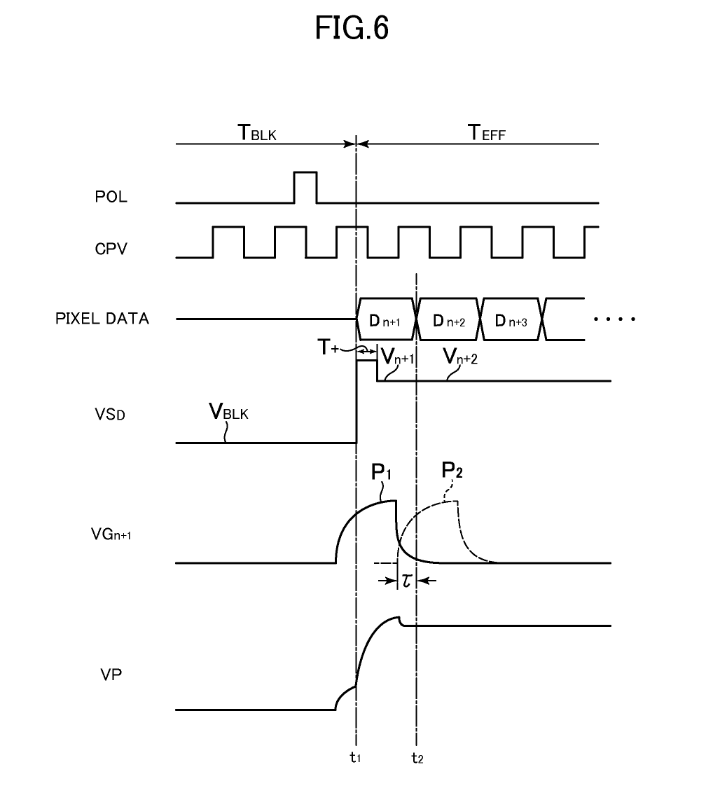

FIG. 6 is a signal waveform diagram illustrating the operation of writing the pixel voltage to a pixel in the head row of the region A_{D} that is the specific display region, and schematically illustrates signal waveforms of the signals VS_{D} and VGₙ₊₁ and the potential VP of the pixel electrode.

Application of the signal voltage Vₙ₊₁ for the head row is started at the time point t₁, and is maintained for a period of 1 H. Time point t₁ occurs when the period τ has elapsed since the rising of the scanning pulse P1. During a part of the period of 1 H, the signal voltage Vₙ₊₁ to be applied to the source line 30 is controlled to be higher than that in the remaining period of the period of 1 H. With this, in the head row, the rising of the potential VP of the pixel electrode during a period after the time point t₁ in the period for applying the scanning pulse is promoted. Thus, the insufficiency in writing of the pixel voltage to a pixel, which is due to an application of the reference potential V_{BLK} before the time point t₁, is eliminated or reduced. In this manner, it is possible to prevent deterioration of the image quality, which is caused because a row other than that at the end of the screen is unnecessarily displayed dark.

The period in which the signal voltage Vₙ₊₁ is increased is set within a period in which the TFT in the head row is turned on, and can be set to the head of the period of 1 H in which the signal voltage Vₙ₊₁ is applied, that is, a predetermined period T₊ starting from the time point t₁ on, for example.

This operation can be achieved by, for example, configuring the control device 26 so as to output a value obtained by increasing the original pixel value by a certain rate as the pixel data to the video line drive circuit 24d during the period T₊ and to output the original pixel value as the pixel data during the remaining period. Further, the video line drive circuit 24d may be configured to cause an overshoot on the signal voltage waveform to be applied to the source line 30 only in the head row.

Further, the control device 26 may increase the signal voltage by a certain rate through the entire period for applying the signal voltage for the head row.

In the above-mentioned respective embodiments, the specific display region is the lower display region A_{D}, and the upper display region A_{U} is not the specific display region. However, conversely, even in a configuration in which A_{U} is set to be the specific display region, and A_{D} is not set to be the specific display region (that is, a configuration in which A_{U} performs vertical scanning from the n-th row toward the first row, and A_{D} performs vertical scanning from the 2n-th row toward the (n+1)th row), or in a configuration in which both of A_{U} and A_{D} are set to be the specific display regions (that is, a configuration in which A_{U} performs vertical scanning from the n-th row toward the first row, and A_{D} performs vertical scanning from the (n+1) th row toward the 2n-th row), one can have a configuration and an operation for compensating for the insufficient writing of the pixel voltage to a pixel in the head row.

Further, in the above-mentioned respective embodiments, the screen includes an even number of pixel rows, and the screen is equally divided into two regions, upper and lower regions, to set the display regions A_{U} and A_{D}. However, the screen may include an odd number of pixel rows, and the numbers of pixel rows forming the respective upper and lower display regions may differ from each other. For example, in the screen including an odd number of pixel rows, the number of pixel rows of one of the display regions A_{U} and A_{D} can be set larger by one than that of the other display region.

Further, this application is also applicable to a horizontal divisional drive involving providing three or more display regions.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A liquid crystal display device, comprising:
video lines, which are provided in each of a plurality of display regions obtained by horizontally dividing a screen including a plurality of pixels arranged in matrix, so as to correspond to respective columns of the plurality of pixels;
a scanning line drive circuit configured to sequentially supply a selection signal to a plurality of scanning lines, which are provided in each of the plurality of display regions so as to correspond to respective rows of the plurality of pixels, to thereby perform vertical scanning of the plurality of display regions in parallel; and
a video line drive circuit configured to:
apply, during a blanking period of the vertical scanning, a predetermined reference voltage to the video lines; and
apply, during an effective scanning period of the vertical scanning, a signal voltage corresponding to a pixel value via one of the video lines to corresponding one of the plurality of pixels in a selected row that is supplied with the selection signal via one of the plurality of scanning lines,
the liquid crystal display device being configured to divisionally drive the screen,
wherein the scanning line drive circuit starts the vertical scanning for a specific scanning display region predetermined out of the plurality of display regions from a pixel row that is adjacent to another of the plurality of display regions, and
wherein the video line drive circuit sets, in at least the specific scanning display region out of the plurality of display regions, an application start timing of the signal voltage related to a supply start timing of a selection signal to be earlier in a selected row at a head of the effective scanning period than in a selected row subsequent thereto.

2. A liquid crystal display device, comprising:
video lines, which are provided in each of a plurality of display regions obtained by horizontally dividing a screen including a plurality of pixels arranged in matrix, so as to correspond to respective columns of the plurality of pixels;
a scanning line drive circuit configured to sequentially supply a selection signal to a plurality of scanning lines, which are provided in each of the plurality of display regions so as to correspond to respective rows of the plurality of pixels, to thereby perform vertical scanning of the plurality of display regions in parallel; and
a video line drive circuit configured to:
apply, during a blanking period of the vertical scanning, a predetermined reference voltage to the video lines; and
apply, during an effective scanning period of the vertical scanning, a signal voltage corresponding to a pixel value via one of the video lines to corresponding one of the plurality of pixels in a selected row that is supplied with the selection signal via one of the plurality of scanning lines,
the liquid crystal display device being configured to divisionally drive the screen,
wherein the scanning line drive circuit starts the vertical scanning for a specific scanning display region predetermined out of the plurality of display regions from a pixel row that is adjacent to another of the plurality of display regions, and
wherein the video line drive circuit applies, in at least the specific scanning display region out of the plurality of display regions, instead of the predetermined reference voltage, a preset voltage corresponding to the pixel value of an intermediate grayscale during a transition period of a predetermined length at an end of the blanking period prior to a start of application of the signal voltage during the effective scanning period.

3. A liquid crystal display device, comprising:
video lines, which are provided in each of a plurality of display regions obtained by horizontally dividing a screen including a plurality of pixels arranged in matrix, so as to correspond to respective columns of the plurality of pixels;
scanning lines provided so as to correspond to respective rows of the plurality of pixels;
a switching element that is provided in each of the plurality of pixels and is configured to control conduction between a pixel electrode and corresponding one of the video lines based on a voltage applied to corresponding one of the scanning lines;
a scanning line drive circuit configured to sequentially apply a selection voltage for passing electricity through the switching element to a plurality of the scanning lines provided in each of the plurality of display regions, to thereby perform vertical scanning of the plurality of display regions in parallel; and
a video line drive circuit configured to:
apply, during a blanking period of the vertical scanning, a predetermined reference voltage to the video lines; and
apply, during an effective scanning period of the vertical scanning, a signal voltage corresponding to a pixel value via one of the video lines to corresponding one of the plurality of pixels in a selected row that is applied with the selection voltage via one of the scanning lines,
the liquid crystal display device being configured to divisionally drive the screen,
wherein the scanning line drive circuit is configured to:
start the vertical scanning for a specific scanning display region predetermined out of the plurality of display regions from a pixel row that is adjacent to another of the plurality of display regions; and
control, in at least the specific scanning display region out of the plurality of display regions, the selection voltage so that the switching element in a selected row at a head of the effective scanning period enters a conductive state with a resistance lower than a resistance of a selected row subsequent thereto.

4. A liquid crystal display device, comprising:
video lines, which are provided in each of a plurality of display regions obtained by horizontally dividing a screen including a plurality of pixels arranged in matrix, so as to correspond to respective columns of the plurality of pixels;
a scanning line drive circuit configured to sequentially supply a selection signal to a plurality of scanning lines, which are provided in each of the plurality of display regions so as to correspond to respective rows of the plurality of pixels, to thereby perform vertical scanning of the plurality of display regions in parallel; and
a video line drive circuit configured to:
apply, during a blanking period of the vertical scanning, a predetermined reference voltage to the video lines; and
apply, during an effective scanning period of the vertical scanning, a signal voltage corresponding to a pixel value via one of the video lines to corresponding one of the plurality of pixels in a selected row that is supplied with the selection signal via one of the plurality of scanning lines,
the liquid crystal display device being configured to divisionally drive the screen,
wherein the scanning line drive circuit starts the vertical scanning for a specific scanning display region predetermined out of the plurality of display regions from a pixel row that is adjacent to another of the plurality of display regions, and
wherein the video line drive circuit sets, in at least the specific scanning display region out of the plurality of display regions, during at least a part of a period of applying the signal voltage corresponding to a pixel value in a selected row at a head of the effective scanning period, the signal voltage to be larger than a signal voltage that is applied to another selected row for the pixel value.
